(19) United States
(12) Patent Application Publication
(10) Pub. No.: US 2011/0305042 A1
(43) Pub. Date: Dec. 15, 2011

(54) MICROCRYSTALLINE WAX FRAGRANCE EMITTING LIGHT

(75) Inventor: Huang Liwei, Shenzhen (CN)

(73) Assignee: Liwei (Hong Kong) Candle Limited, Central Hong Kong (CN)

(21) Appl. No.: 13/157,694

(22) Filed: Jun. 10, 2011

(30) Foreign Application Priority Data
Jun. 13, 2010 (CN) 201020233146.8

(51) Int. Cl. H01R 33/00; F21V 33/00

(52) U.S. Cl. 362/643; 362/253

(57) ABSTRACT

A microcrystalline wax fragrance emitting light comprises (1) a light body with a light source creating heat and (2) a microcrystalline wax which acts as an emission media, emits fragrance, is mounted on said light body, detachable, and replaceable from said light body. The microcrystalline wax acts as a fragrance emission media which emits fragrance and is supplemented on the decorative lighting, enables the lighting to illuminate, decorate, and release fragrance continuously. The microcrystalline wax used in the present invention mainly utilizes the heat of the light source to facilitate the release of fragrance, whereby provides stronger fragrance emission. In addition, the microcrystalline wax which acts as an emission media is detachable and replaceable from the decorative lighting, allows a user to replace it freely with an emission media according to the user's favored shape and fragrance.

### TECHNICAL FIELD

The present invention relates to a decorative lighting, particularly to a microcrystalline wax fragrance emitting light which can release fragrance.

### BACKGROUND ART

A decorative lighting is a common decorative electrical article. The existing decorative lightings employ the incandescent lamps, energy-saving lamps and LED lamps, etc., at relatively low power consumption. These kinds of decorative lightings, when using, have a limited function of decoration and illumination only.

### SUMMARY OF THE INVENTION

In view of the above, the present invention aims to provide a microcrystalline wax fragrance emitting light not only for decoration and illumination but also for releasing fragrance.

A microcrystalline wax fragrance emitting light comprises a light body which acts as a light source giving an amount of heat and a microcrystalline wax acting as a fragrance emission media which can emit fragrance and is mounted on the light body. Said emission media is detachable to the light body.

As an embodiment of the above solution, the emission media can be block shaped, an arcuate clip is fixed on the emission media perpendicular to the surface thereof, the arcuate clip is clipped onto the light body, and the emission media is adjacent to the light source and releases fragrance through the heat generated by the light source.

As another embodiment of the above solution, the emission media can half or fully surround the light source, the emission media is clipped onto the light body by the arcuate clip, and the emission media is adjacent to the light source and releases fragrance through heat generated by the light source.

As a further embodiment of the above solution, the emission media is hollow and provided with an insertion hole at the bottom. A spring clip is fixed on the light body. The light body is inserted into the hole of emission media with the spring clip clipped in place.

In addition, the light source can be powered by batteries or external electric supply.

In the present invention, the microcrystalline wax acts as a fragrance emission media which can emit fragrance, and is supplemented on the decorative lighting. The microcrystalline wax enables the decorative lighting to not only exhibit decoration and illumination, but also to release fragrance continuously, whereby enriches functions of the decorative lighting and effect of the application. The microcrystalline wax used in the present invention mainly utilizes the heat of the light source to facilitate the release of fragrance from the microcrystalline wax, whereby the stronger fragrance is emitted and the effect gets better. In addition, the microcrystalline wax which acts as an emission media is detachable from the decorative lighting and replaceable. In this way, it allows a user to replace it freely with an emission media per his/her favored shape and favored type of fragrance, and becomes more flexible in use.

### DESCRIPTION OF THE DRAWINGS

FIG. 1 is a schematic view of the embodiment 1 of the present invention;

FIG. 2 is a schematic view of the embodiment 2 of the present invention;

FIG. 3 is a schematic view of the embodiment 3 of the present invention.

Further illustrations will be made as follows in conjunction with the accompanying drawings.

### PREFERRED EMBODIMENTS

To overcome deficiencies in the prior art, more thorough solutions are provided in several embodiments of the present invention.

### Embodiment 1

As shown in FIG. 1, a microcrystalline wax fragrance emitting light disclosed in this embodiment is mainly constituted by a light body 1, a light source 11 and a microcrystalline wax which acts as an emission media 2 and can emit fragrance. The light body is configured with a power plug for inserting into power plug jacks to supply power for the light source 11; alternatively, the light can be powered by batteries, with a battery compartment provided in the light body 1 for the accommodation of batteries. The light source 11 of the invention embodiment can be a low power incandescent lamp which can emit relatively low heat, and of course, it can be an energy saving lamp, an LED lamp, and the like which is capable of heat emission.

The emission media 2 of the present solution can be block shaped, or in other different shapes which can work as a shade for the light source 11, and it can be added with patterns or decorations on the external surface. In order to detach and replace the emission media 2 in a convenient way, an arcuate clip 21 is fixed on the emission media 2 perpendicular to the surface thereof, the arcuate clip 21 can be clipped onto the light body 1, thereby allowing the emission media 2 positioned adjacent to the light source 11, such that the heat generated from the light source 11 facilitates the microcrystalline wax, which acts as an emission media, to emit fragrance.

The light body 1 can be associated with numerous types of emission media 2 which can be manufactured into different shapes, such as square shape, round shape or animal shape, or they can carry different patterns or decorations, such as flowers, birds, insects, fishes, etc. The emission media can be replaced by users freely per their choice or on their demands during use, and it is convenient and flexible to use.

### Embodiment 2

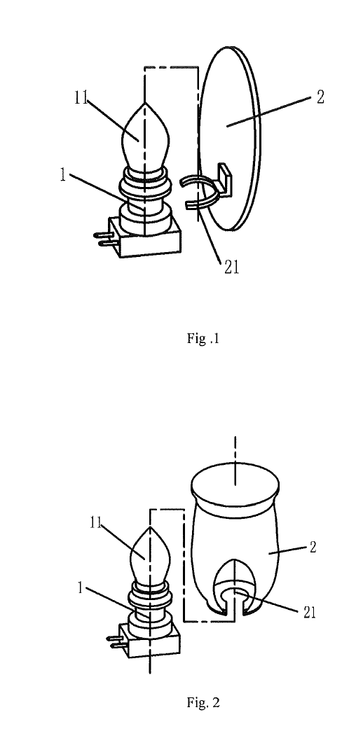

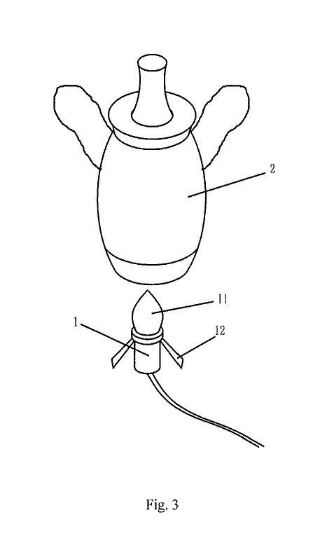

As shown in FIG. 2, a microcrystalline wax fragrance emitting light disclosed in the invention embodiment is also mainly constituted by a light body 1, a light source 11 and a microcrystalline wax 2 which acts as an emission media 2. Likewise, the light body is configured with a power plug for inserting into power plug jacks to supply power for the light source 11; alternatively, the light can be powered by batteries as well, with a battery compartment provided in the light body 1 for the accommodation of batteries. The light source 11 of the invention embodiment can be a low power incandescent lamp which can emit relatively low heat, and of course, it can be an energy-saving lamp, an LED lamp, and the like which is capable of heat emission.

The emission media 2 of the present solution can be a surrounding shade or housing, for example, an inverted lamp shape. The emission media 2 can be in different shapes. The emission media 2 in its lower portion is a contracted opening to form an arcuate clip 21 which is clipped onto the light body 1, whereby a construction is formed that the emission media 2 covers the light source 11. Heat emitted from the light source 11 facilitates the microcrystalline wax which acts as an emission media, to diffuse fragrance. Additionally, the lamp shade emission media 2 can be manufactured into other shapes, such as a half-surrounding shade or a full-surrounding housing, which allows the users to replace the emission media per their choice during use.

### Embodiment 3

As shown in FIG. 3, a microcrystalline wax fragrance emitting light disclosed in the invention embodiment is also mainly constituted by a light body 1, a light source 11 and a microcrystalline wax which acts as an emission media 2 to emit fragrance. An external power cord is connected to the light body 1. Alternatively, the light can be powered by batteries, with a battery compartment provided in the light body 1 for the accommodation of batteries. The light source 11 of the invention embodiment can be a low power incandescent lamp which can emit relatively low heat, and of course, it can be an energy-saving lamp, an LED lamp, and the like which is capable of heat emission.

The emission media 2 of the present solution also has a surrounding structure, and particularly a shape of a tubular ornamental. The light body 1 is inserted into the hole of emission media 2 with the spring clip 12 clipped in place, whereby it is to press the spring clip 12 to pull it from the bottom of the emission media 2 for disassembly.

The tubular emission media 2 of the present design can be manufactured into different shapes such as sphere, ellipsoid, cylinder, and with different finishes for decoration, such as natural look finish, decal, Christmas design, embossed finish or engraved finish, and so on, which can be replaced freely per the choice of users.

The aforementioned embodiments that are given are for purpose of explaining how to attain the object of the invention, which are considerably specific and detailed. However, the embodiments should not be defined or interpreted as a limit to the scope of the invention. Transformations or improvements may be made based on the idea of the present invention but they should be also within the scope of this invention.

1. A microcrystalline wax fragrance emitting light, comprising a light body (1) provided with a light source (11) generating an amount of heat, characterized in that, a microcrystalline wax acting as an emission media (2) to emit fragrance is mounted on said light body, wherein said emission media is detachable from said light body and replaceable.

2. The microcrystalline wax fragrance emitting light according to claim 1, characterized in that, said emission media is block shaped, an arcuate clip (21) is fixed on said emission media perpendicular to the surface thereof, said clip is clipped onto said light body, said emission media is adjacent to said light source and releases fragrance through heat generated by the light source.

3. The microcrystalline wax fragrance emitting light according to claim 1, characterized in that, said emission media half or fully surrounds said light source, said emission media is clipped onto said light body by an arcuate clip (21), said emission media is adjacent to said light source and releases fragrance through heat generated by the light source.

4. The microcrystalline wax fragrance emitting light according to claim 1, characterized in that, said emission media is provided with an insertion hole, a spring clip (12) fixed on the light body is inserted into said insertion hole and clipped in place.

5. The microcrystalline wax fragrance emitting light according to claim 1, characterized in that, said light source is powered by batteries or external electric supply.

6. The microcrystalline wax fragrance emitting light according to claim 2, characterized in that, said light source is powered by batteries or external electric supply.

7. The microcrystalline wax fragrance emitting light according to claim 3, characterized in that, said light source is powered by batteries or external electric supply.

8. The microcrystalline wax fragrance emitting light according to claim 4, characterized in that, said light source is powered by batteries or external electric supply.

9. The microcrystalline wax fragrance emitting light according to claim 1, characterized in that, said emission media fully surrounds said light source, said emission media is clipped onto said light body by an arcuate clip (21), said emission media is adjacent to said light source and releases fragrance through heat generated by the light source.

10. The microcrystalline wax fragrance emitting light according to claim 9, wherein said emission media is tubular in shape.

11. The microcrystalline wax fragrance emitting light according to claim 11, wherein said surrounding emission media housing is an inverted lamp shape.

12. The microcrystalline wax fragrance emitting light according to claim 3, wherein said emission media is sphere in shape.

13. The microcrystalline wax fragrance emitting light according to claim 3, wherein said emission media is ellipsoid in shape.

14. The microcrystalline wax fragrance emitting light according to claim 3, wherein said emission media is cylinder in shape.

15. The microcrystalline wax fragrance emitting light according to claim 1, wherein said emission media is square in shape.

16. The microcrystalline wax fragrance emitting light according to claim 1, wherein said emission media is round in shape.

17. The microcrystalline wax fragrance emitting light according to claim 1, wherein said emission media is in an animal shape.

18. The microcrystalline wax fragrance emitting light according to claim 1, wherein said emission media is in a flower shape.

19. The microcrystalline wax fragrance emitting light according to claim 1, wherein said emission media have decoration finishes,

20. The microcrystalline wax fragrance emitting light according to claim 19, wherein said decoration finishes on the emission media are selected from a group consisting of natural look finish, decal, Christmas design, embossed finish, and engraved finish.
